(19) United States
(12) Patent Application Publication
(10) Pub. No.: US 2009/0071984 A1
(43) Pub. Date: Mar. 19, 2009

(54) Metering Device with a Rotary Block

(75) Inventor: Jean-Charles Marchadour, Pont L'Abbe (FR)

Correspondence Address: YOUNG & THOMPSON, 209 Madison Street, Suite 500, ALEXANDRIA, VA, 22314, US

(73) Assignee: TREMARK TECHNOLOGIES, INC., Quebec (CA)

(21) Appl. No.: 11/918,672

(22) PCT Filed: Apr. 7, 2006
(86) PCT No.: PCT/FR2006/000772

§ 371 Date: Oct. 17, 2007

(30) Foreign Application Priority Data
Apr. 20, 2005 (FR) 05 03945

(51) Int. Cl. G01F 11/00

(52) U.S. Cl. 222/218

(57) ABSTRACT

A device for metering product, includes a stationary stand, at least one block (6) mounted to pivot about an axis on the stand, and at least one metering chamber (8) having an axis that is transverse relative to the pivot axis of the block and that opens out laterally to the outside of the block, a delivery piston (10) being mounted in the metering chamber to slide parallel with the axis of the chamber. The piston is secured to a rack (11) engaging a pinion (12) that is mounted on the block to rotate about an axis parallel to the pivot axis of the block. Drive elements for rotating the pinion are connected to the stand, and the device includes holder elements for holding the piston in a position that is substantially constant during pivoting of the block.

The present invention relates to a volumetric metering device suitable for use, for example, for metering products that are liquid, pasty, or in lump or in powder form, and in particular in the food industry. Such products include pasta, beans in pods or podded, rice, spinach, sauerkraut, ground or diced meat, sliced potatoes, tabbouleh, celeriac salad, vinaigrette and other sauces, . . . .

By way of example, such a device is placed between a hopper containing the product in bulk and a conveyor of receptacles for filling.

### BACKGROUND OF THE INVENTION

Document FR-A-2 843 799 discloses a product metering device comprising a stationary stand and a block that is mounted to pivot on the stand and that includes a metering chamber having an axis extending across the block to open out laterally to the outside of the block on either side thereof. The block is mounted to pivot between a position for admitting product into the metering chamber and a position for delivering product from the metering chamber. The metering device includes introduction and expulsion means for introducing product into the metering chamber and for expelling product from the metering chamber. The introduction and expulsion means comprise a suction piston and an expulsion piston mounted on the stand to slide transversely relative to the block and penetrate into the metering chamber when the block is in the corresponding positions, in such a manner that each piston has a position retracted from the block and a position received inside the metering chamber. That device is effective at providing metering that is accurate and fast. However the structure of the device is relatively complex and it is difficult to achieve sealing between the pistons and the chamber.

Document DE-A-35 11 288 also discloses a product metering device comprising a stationary stand and a block that is mounted to rotate on the stand and that has metering chambers, each having an axis extending transversely relative to the block so as to open out laterally to the outside of the block and also to the center thereof. A piston is mounted in each chamber to slide parallel to the axis of the chamber and it carries a wheel that runs on a stationary cam that is extends through the center of the block. The cam has a profile arranged, during rotation of the block, to move the pistons between two axially-offset positions for the purpose of admitting a predetermined quantity of product and of delivering the product as metered in this way. Movement of the piston is inseparably associated with rotation of the block. That device thus presents the drawback of requiring a plurality of cams to be available, each adapted to a particular volume to be metered. It is also difficult to vary the speed at which the product is metered.

### OBJECT OF THE INVENTION

An object of the invention is to provide a metering device of a structure that is relatively simple and that is flexible in use, while being accurate.

### BRIEF DESCRIPTION OF THE INVENTION

To this end, the invention provides a device for metering product, the device comprising a stationary stand, at least one block mounted to pivot about an axis on the stand, and including at least one metering chamber having an axis that is transverse relative to the pivot axis of the block and that opens out laterally to the outside of the block, a delivery piston being mounted in the metering chamber to slide parallel with the axis of the chamber. The piston is secured to a rack engaging a pinion that is mounted on the block to rotate about an axis parallel to the pivot axis of the block, drive means for rotating the pinion are connected to the stand, and the device includes holder means for holding the piston in a position that is substantially constant during pivoting of the block.

Thus, the movement of the piston is dissociated from the pivoting movement of the block such that the parameters of these movements are independent. Nevertheless, since the pinion is of non-zero radius, the point of contact between the pinion and the rack tends to move during pivoting of the block, such that pivoting the block tends to cause the rack to move and thus to cause the piston to move if the pinion remains stationary. The holder means serve to prevent movement of the piston which would be harmful for the accuracy of metering, and thus serves to maintain metering that is accurate. The structure of the device is nevertheless relatively simple and easy to manufacture.

Preferably, the holder means are arranged to keep the point of contact between the pinion and the rack substantially constant, and in particular, to compensate for relative movement between the pinion and the rack as generated by the block pivoting.

Compensating the relative movement of the pinion and of the rack serves to limit the influence of pivoting the block on the position of the piston. This compensation can be achieved in simple manner by appropriately controlling the means for driving the pinion in rotation.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a fragmentary diagrammatic elevation and section view of a metering device in accordance with the invention in a product-packaging installation;

FIGS. 2 and 3 are cross-section views of the metering device in positions at the beginning and at the end of admission; and

FIGS. 4 and 5 are cross-section views of the metering device in positions at the beginning and at the end of delivery.

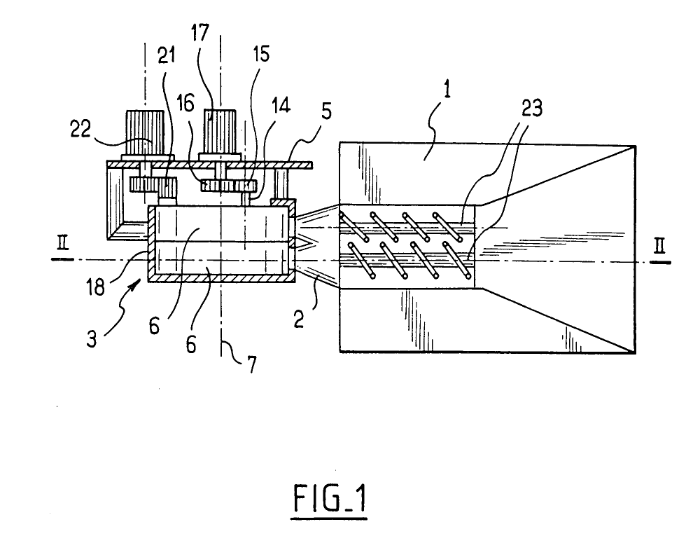

### DETAILED DESCRIPTION OF THE INVENTION

With reference to the figures, the packaging device comprises a hopper 1 for supplying a product, the hopper having a bottom connected by a duct 2 to a metering device, given overall reference 3, situated facing a portion of a conveyor 4 conveying receptacles, each of which is to be filled with a predetermined quantity of product. The hopper 1 and the conveyor 4 are known in themselves and they are not described herein.

The metering device 3 comprises a stationary stand 5 on which two blocks 6 are mounted to pivot about an axis 7. The two blocks 6 are identical, superposed, and connected to each other.

Each block 6 has a metering chamber 8 with an axis 9 (in this case a diametral axis) perpendicular to the axis 7 and opening to the outside of the block 6 on either side thereof. The metering chamber 6 may have a cross-section that is rectangular, circular, or of some other shape.

A piston 10 is mounted in the metering chamber 8 to slide parallel to the axis 9 between a first position where it is flush with the outside surface of the block 6 and a second position that is set back by a distance corresponding to the quantity of product to be metered. The product is received in the metering chamber 8 beside the front face of the piston 10. The piston 10 has a rear portion secured to a rack 11 extending parallel to the axis 9.

The racks 11 mesh with a single pinion 12 mounted on the block 6 to rotate about an axis 13 parallel to the axis 7.

The pinion 12 is secured to one end of a shaft 14 that has an opposite end fitted with a gearwheel 15 meshing with the outlet gearwheel 16 of a servomotor 17 on the axis of the block 6.

The blocks 6 are received to pivot in an enclosure 18 that is secured to the stand 5 and that is provided laterally with an admission opening 19 and with a delivery opening 20 disposed in register with each metering chamber 8 and respectively facing the duct 2 and the conveyor 4. The block 6 has a toothed sector 21 that meshes with an outlet gearwheel of a servomotor 22 for driving pivoting of the blocks 6 between an admission position in which the metering chamber 8 faces the admission opening 19, and a delivery position in which the metering chamber 8 faces the delivery opening 20. The two positions of each block 6 are therefore angularly offset relative to each other.

The enclosure 18 is mounted on the stand 5 to pivot eccentrically about a vertical axis opposite from the hopper 1, between a working position in which the admission openings 19 face the duct 2, and a cleaning position in which the admission openings 19 are disengaged from the duct 2.

Beside the rear faces of the pistons, the blocks 6 include respective flats leaving spaces 24 into which the metering chambers 8 open out. These spaces are used when metering a liquid. In the event of leakage past the piston, the liquid that passes to the rear side of the piston is received in the space 24 so as to avoid exerting pressure on the back of the piston that would prevent the piston moving backwards.

The operation of the installation is described below, concentrating on only one of the blocks 6, since both operate in the same manner.

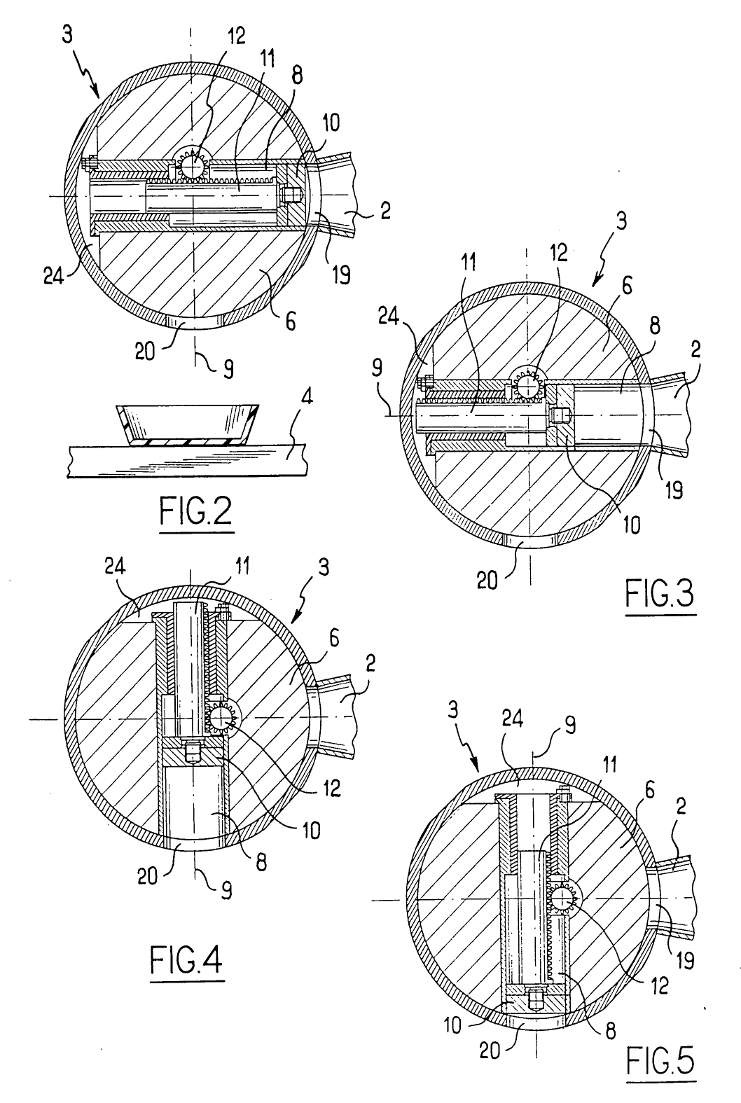

At the beginning of a metering cycle, the blocks 6 are in the admission position and the pistons 10 are in the first position (FIG. 2).

The feed screws 23 situated in the bottom of the hopper are controlled to push the product into the duct 2 and into the metering chambers 8, while the servomotor 17 is controlled to drive the gearwheel 12 to rotate so as to bring the pistons 10 from their first position towards their second position (FIG. 3).

When the pistons 10 are in their second position, the servomotor 22 is controlled to bring the blocks 6 into their delivery position, and simultaneously the servomotor 17 is controlled to keep the pistons 10 in their second position throughout the rotation of the blocks 6 (FIG. 4).

It should be observed that during rotation of the blocks 6, the metering chambers 8 are closed by the wall of the enclosure 18, which prevents the product from escaping.

When the blocks have reached their delivery position, the servomotor 17 is controlled to move the pistons 10 towards their first position (FIG. 5). The pistons 10 thus expel the product from the metering chambers 8. Two measured quantities of product then drop into one of the receptacles to be filled.

It should be observed that the piston 10 may be sealed in such a manner that the pistons 10 suck product into the metering chamber 8. Provision can also be made for the feed screws 23 to press the product into the metering chambers 8.

Naturally, the invention is not limited to the embodiment described and various embodiments can be applied thereto without going beyond the ambit of the invention as defined by the claims.

In particular, the means for driving the pinion may be different from those described and may comprise a set of gears or a set of pulleys and a belt interposed between the pinion and the motor, or indeed a linear actuator connected to a rack for driving the pinion.

In addition, the holder means may be of a structure different from that described and may include a clutch disposed between the pinion 12 and the outlet gearwheel 16 of the drive motor so as to leave the pinion 12 free to rotate when the block pivots. Thus, with a block having a vertical pivot axis, the rack remains stationary during pivoting of the block, and it drives the pinion in rotation. It is nevertheless then necessary for the pinion to offer little or no resistance to being rotated.

Assuming a small offset between the point of contact of the rack with the pinion and the pivot axis, then a lost-motion connection can be interposed between the rack and the piston to absorb the displacement of the rack during pivoting of the block (in which case the device is preferably arranged so that pivoting of the block from its suction position towards its delivery position causes the rack to move forwards).

Furthermore, the metering device need have only one block or it could have more than two blocks, the angular positions of the block may be offset by an angle other than 90°, the pivot axis of the block may be vertical, . . . .

In its first position, the piston may project from the metering chamber 8, so that when the block is in the delivery position, it is certain that no product remains attached at the outlet from the metering chamber.

The means for introducing product into the chambers may be different from the screws 23, e.g. they could comprise a conveyor belt.

The means for holding the piston may be arranged to enable the piston to perform a small amount of compression or expansion movements while the block is pivoting, in particular when the metering chamber is no longer facing the admission opening.

1-6. (canceled)

7. A device for metering product, the device comprising a stationary stand (5), at least one block (6) mounted to pivot about an axis (7) on the stand, and including at least one metering chamber (8) having an axis (9) that is transverse relative to the pivot axis of the block and that opens out laterally to the outside of the block, a delivery piston (10) being mounted in the metering chamber to slide parallel with the axis of the chamber, wherein the piston is secured to a rack (11) engaging a pinion (12) that is mounted on the block to rotate about an axis parallel to the pivot axis of the block, wherein drive means (15, 16, 17) for rotating the pinion are connected to the stand, and wherein the device includes holder means (17) for holding the piston in a position that is substantially constant during pivoting of the block.

8. A device according to claim 7, wherein the holder means (17) are arranged to keep the point of contact between the pinion (12) and the rack (11) substantially constant.

9. A device according to claim 8, wherein the holder means (17) are arranged to compensate for relative movement between the pinion (12) and the rack (11) as generated by the block pivoting.

10. A device according to claim 7, wherein an enclosure (18) surrounds the block (6), the enclosure presenting, level with the metering chamber (8), at least one lateral admission opening (19) and at least one lateral delivery opening (20), which openings are angularly offset relative to each other.

11. A device according to claim 10, wherein opposite from the metering chamber (8) and in communication therewith, the block (6) includes a space (24).

12. A device according to claim 7, including at least two blocks (6) that are superposed and secured to each other, each having a piston (10) and a rack (11), the racks meshing with the same pinion (12).
